(19) United States
(12) Patent Application Publication
(10) Pub. No.: US 2026/0022697 A1
(43) Pub. Date: Jan. 22, 2026

(54) ELECTROMECHANICAL ACTUATION NETWORK WITH INTEGRATED COOLING PUMP

(71) Applicant: Hamilton Sundstrand Corporation, Charlotte, NC (US)

(72) Inventors: Naison Mastrocola, Goshen, CT (US); Ryan Susca, Windsor, CT (US)

(21) Appl. No.: 18/775,777

(22) Filed: Jul. 17, 2024

(51) Int. Cl. F04B 49/22; F02C 7/14

(52) U.S. Cl. CPC F04B 49/22; F02C 7/14

(57) ABSTRACT

A fluid system includes a fluid inlet, a boost pump fluidically coupled to the fluid inlet, a check valve network fluidically coupled to the boost pump and to the fluid inlet, and an actuation network fluidically coupled to the check valve network. The actuation network comprises at least one actuator having an integrated pump. The fluid system further includes a fluid outlet path fluidically coupled to the actuation network. The integrated pump within the actuation network allows for thermal cooling of actuators within the actuation network. This allows for mitigation of thermal soak back effects when the engine housing the fluid system is in an off condition.

### CROSS-REFERENCE TO RELATED APPLICATION(S)

This application is related to U.S. application Ser. No. ______ filed on Jul. 17, 2024, entitled “ELECTROMECHANICAL ACTUATION NETWORK WITH INTEGRATED COOLING RESERVOIR” with Attorney Docket No. 180280US01-U200-P15614US1.

### BACKGROUND

This disclosure relates to pressure-controlled pump systems and, more particularly, to pressure-controlled pump systems that include thermal management for actuators. In traditional pressure-controlled pump systems, pumps supply fluid to actuators among other potential system components. Thermal conditions surrounding the actuator may impact operability and service life of the actuators. Thus, a configuration which allows the actuator to remain operable in high temperature conditions is desirable.

### SUMMARY

A fluid system includes a fluid inlet, a boost pump fluidically coupled to the fluid inlet, a check valve network fluidically coupled to the boost pump and to the fluid inlet, and an actuation network fluidically coupled to the check valve network. The actuation network includes at least one actuator having an integrated pump. The fluid system further includes a fluid outlet path fluidically coupled to the actuation network.

A method for a fluid circuit to provide cooling to an actuation network, the fluid circuit including a fluid inlet, a boost pump fluidically coupled to the fluid inlet, a check valve network fluidically coupled to the check valve network and fluidically coupled to a main pump, and a fluid outlet path fluidically coupled to the actuation network, includes directing fluid from the fluid inlet to the control valve network. The method further includes activating one or more integrated pumps within the actuation network. The method further includes pumping cooling flow from the control valve network to the actuation network via operation of the one or more integrated pumps. The method further includes directing the cooling flow from the actuation network to the fluid outlet path.

### BRIEF DESCRIPTION OF THE DRAWINGS

FIG. 1 is a block diagram of a fluid system including an actuation network with an integrated cooling pump.

FIG. 2 is a schematic diagram of the fuel system including the actuation network with the integrated cooling pump.

FIG. 3 is a flowchart depicting a method for providing cooling flow to the actuation network via the integrated cooling pump within the fuel system.

### DETAILED DESCRIPTION

The techniques of this disclosure relate to a fluid system having an actuation network with an integrated cooling pump. The fluid system provides for an electromechanical actuation network which allows for higher fuel efficiency than other actuation systems. The actuation network requires cooling as the electronic components within electromechanical actuators (EMAs) are typically unable to withstand the temperatures in a fuel pump environment. During operation of the fluid system, cooling flow (e.g., cooling fuel) keeps the actuator network at an appropriate temperature for operation. Upon engine shutdown, however, thermal soak back can occur, thereby imparting high temperatures upon the EMAs without the cooling flow from normal operation of the fluid system. The techniques of this disclosure include using an integrated pump housed within the actuator network to provide cooling flow during engine shutdown. The techniques of this disclosure thus allow EMAs to remain cool upon engine shutdown.

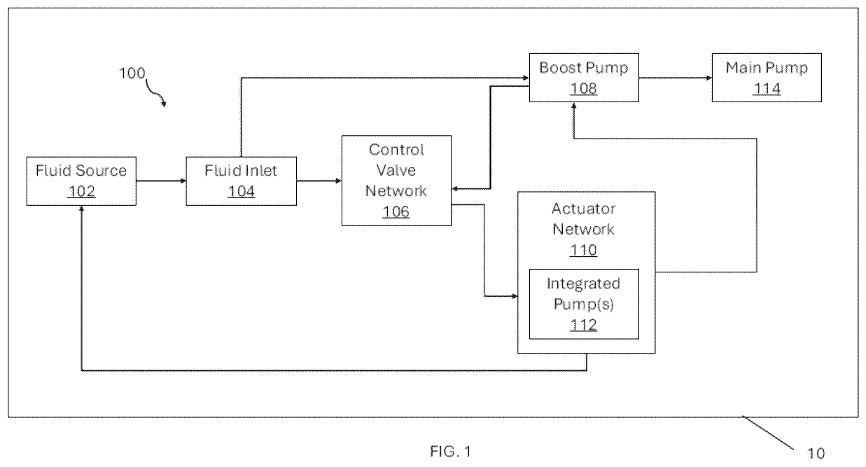

FIG. 1 is a block diagram of an example of fluid system 100. Fluid system 100 is housed within engine 10, wherein engine 10 can be, for example, a gas turbine engine. Fluid system 100 includes fluid source 102, fluid inlet 104, control valve network 106, boost pump 108, actuator network 110, and main pump 114. Actuator network 110 includes integrated pump(s) 112. Fluid source 102 is a fuel source containing cooling fuel (e.g., a fuel tank). Control valve network 106 can include one or more control valves for controlling cooling fuel flow through fluid system 100. The one or more control valves can be configured to open or close in response to fluid pressure generated by boost pump 108. The one or more control valves can be, for example, electro-hydraulic servo valves (EHSV).

Boost pump 108 can be any suitable pump operable to increase fluid pressure of fluid flowing through fluid inlet 104. Examples of boost pump 108 include non-positive displacement pumps and positive displacement pumps and can be mechanically driven and/or electrically driven. In some examples, boost pump 108 can be a centrifugal pump, or other non-positive displacement pump, that is mechanically-driven. Main pump 114 is used to deliver fuel to a fuel injector in the combustion section of engine 10 through, for example, a distribution system.

Actuator network 110 can include any number of actuators. Each of the actuators within actuator network 110 can be an electromechanical actuator (EMA). Electromechanical actuators can be linear EMAs or rotary EMAs that are coupled to one or more variable geometry components operatively associated with fluid system 100. Actuator network 110 can also include a control unit associated with each EMA. Control units can include a processor, a microprocessor, a controller, a digital signal processor (DSP), an application specific integrated circuit (ASIC), a field-programmable gate array (FPGA), or other equivalent discrete or integrated logic circuitry that governs operation of respective electromechanical actuators. Control units can be associated with a temperature rating above which operation life of the control unit is degraded or non-operative. Integrated pump(s) 112 can be one or more bi-directional pumps configured to spin the EMAs of actuator network 110 in either rotational direction. Integrated pump 112 can be a centrifugal pump integrated to the intermediate gearing of a mechanical driveline of an EMA within actuator network 110.

In an example configuration, fluid source 102 is fluidly coupled to fluid inlet 104. Fluid inlet 104 is fluidly coupled to control valve network 106 and to boost pump 108. Control valve network 106 is fluidly coupled to boost pump 108 and actuator network 110. Actuator network 110 is fluidly coupled to boost pump 108 and/or fluidly coupled to fluid source 102.

In an example, while engine 10 is operational, fluid is conducted from fluid source 102 to fluid inlet 104 and through boost pump 108. Boost pump 108 supplies pressurized fluid to main pump 114. Main pump 114 can be connected to a downstream distribution system (not pictured) for providing fuel to a combustor within the gas turbine engine. The control valves of control valve network 106 can be opened and/or closed in response to pressure generated by boost pump 108. Fluid can then flow from control valve network 106 to actuator network 110 in cases where actuation is required. After actuation, fluid can flow from actuator network 110 back through boost pump 108 for supply to main pump 114. Fluid can additionally or alternatively flow from actuator network 110 to fluid source 102.

In the example described, while engine 10 is operational, fluid flow through actuator network 110 allows for thermal cooling, thereby allowing the actuator(s) within actuator network 110 to withstand the surrounding high temperatures. While engine 10 is in an off state, boost pump 108 is not operational and thermal soak back can occur, thereby subjecting actuator network 110 to high temperatures. Fluid system 100 allows for cooling flow to continue flowing through actuator network 110 in the engine off condition. In operation, integrated pump(s) 112 activate to pump fluid from fluid source 102 through fluid inlet 104, through control valve network 106, and into actuator network 110. Control valve network 106 can be configured such that the control valve(s) contained within control valve network 106 restrict flow from traveling to boost pump 108 in the engine off condition and instead direct flow to actuator network 110. Fluid flow through actuator network 110 allows for cooling of the actuator(s) within actuator network 110. Fluid can flow from actuator network 110 to the inlet of boost pump 108 and thereafter recirculate through fluid system 10. Additionally or alternatively, fluid can flow from actuator network 110 to fluid source 102 (e.g., a fluid tank), thus replenishing fluid source 102.

In the example described, fluid system 100 provides several advantages. Fluid system 100 allows for EMAs within actuator network 110 to receive cooling flow from fluid source 102 in both engine on and engine off conditions. Thermal soak back that can occur in engine off conditions is mitigated by integrated pump(s) 112 which drive cooling flow from fluid source 102, through fluid inlet 104, through control valve network 106 and to the EMAs within actuator network 110. Further, the components required to add integrated pump(s) 112 to actuator network 110 are minimal. The components of integrated pump(s) 112 can include, for example, a housing and an impeller. Thus, a minimal amount of size and weight is added to fluid system 100 in order to allow for mitigation of the effects of thermal soak back.

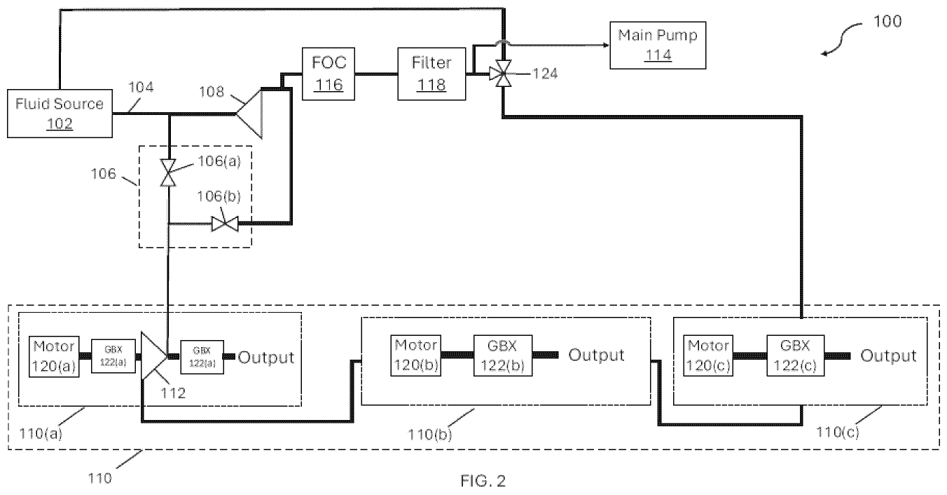

FIG. 2 is a schematic diagram of an example of fluid system 100. Fluid system 100 includes the same components detailed in the block diagram depiction of FIG. 1, including fluid source 102, fluid inlet 104, control valve network 106, boost pump 108, actuator network 110 including integrated pump 112, and main pump 114.

The depiction of FIG. 2 includes additional examples of details of fluid system 100, as shown by the inclusion of fuel oil cooler 116, filter 118, and selector valve 124. Control valve network 106, shown in more detail, may include control valve 106(a) and control valve 106(b). It is understood that any number of control valves can be used within control valve network 106. In the depicted embodiments, control valve 106(a) and control valve 106(b) are spring loaded valves. Control valve 106(a) is spring loaded such that control valve 106(a) defaults to an open position and control valve 106(b) is spring loaded such that control valve 106(b) defaults to a closed position.

Actuator network 110, an example of which is shown in more detail, depicts a plurality of actuators including actuator 110(a), actuator 110(b), and actuator 110(c). It is understood that fuel system 100 can include any number of actuators. Actuator 110(a) includes motor 120(a), gearbox 122(a), and integrated pump 112. Actuator 110(b) includes motor 120(b) and gearbox 122(b). Actuator 110(c) includes motor 120(c) and gearbox 122(c).

In an example configuration, fluid source 102 is fluidly coupled to fluid inlet 104. Fluid inlet 104 is fluidly coupled to control valve network 106 and to boost pump 108. Control valve network 106 is fluidly coupled to boost pump 108 and actuator network 110. Boost pump 108 is fluidly coupled to main pump 114 via a flow path through fuel oil cooler 116 and filter 118. Actuator network 110 is fluidly coupled to fluid source 102 and boost pump 108 via selector valve 124.

In an example, within actuator network 110, actuator 110(a), actuator 110(b), and actuator 110(c) are fluidly connected in a series arrangement such that fluid flows from actuator 110(a) to actuator 110(b), to actuator 110(c), then to fluid source 102 or boost pump 108 via selector valve 124. Within actuator 110(a), motor 120(a) is mechanically coupled to gearbox 122(a) and integrated pump 112. Integrated pump 112 is positioned along a mechanical driveline of gearbox 122(a). Actuator 110(a) is mechanically coupled to an output which is actuated when actuator 110(a) is functional. Within actuator 110(b), motor 120(b) is mechanically coupled to gearbox 122(b). Within actuator 110(c), motor 120(c) is mechanically coupled to gearbox 122(c).

As described in the description of FIG. 1, fluid system 100 can be contained within an engine. While the engine is operational, fluid is conducted from fluid source 102 to fluid inlet 104. Boost pump 108 pressurizes the fluid for delivery to main pump 114 through fuel oil cooler 116 and filter 118. Fuel oil cooler 116 cools the fluid flow from boost pump 108, and filter 118 filters contaminants within the fluid flow from boost pump 108.

The control valves of control valve network 106 can be opened and/or closed in response to pressure generated by boost pump 108. In the depicted embodiments, the fluid pressure generated by boost pump 108 biases control valve 106(a) to a closed position and biases control valve 106(b) to an open position. Thus, during operation of the engine, fluid is permitted to flow through control valve 106(b) to actuator network 110.

As described in the description of FIG. 1, while the engine is operational, fluid flow through actuator network 110 allows for thermal cooling, thereby allowing actuator 110(a), actuator 110(b), and actuator 110(c) within actuator network 110 to withstand the surrounding high temperatures. While the engine is in an off state, boost pump 108 is not operational and thermal soak back can occur, thereby subjecting actuator network 110 to high temperatures.

In an example, fluid system 100 allows for cooling flow to continue flowing through actuator network 110 in an engine off condition. In operation, integrated pump 112 activates in order to pump fluid from fluid source 102 through fluid inlet 104, through control valve network 106, and into actuator network 110. In the depicted embodiment, control valve 106(a) is open due to the spring loading withing control valve 106(a). Control valve 106(b) is closed due to the spring loading within control valve 106(b). Thus, fluid is directed through valve 106(a), and does not flow through boost pump 108.

In an example, fluid flow through actuator network 110 allows for cooling of actuators 110(a), 110(b), and 110(c) within actuator network 110. Fluid flows through actuators 110(a), 110(b), and 110(c) in series, allowing for cooling of motor 120(a), motor 120(b), and motor 120(c). While the depicted embodiment shows a singular integrated pump (i.e., integrated pump 112), it is understood that any number of integrated pumps can be used in this disclosure. For example, additional pumps can be integrated along the mechanical driveline of gearbox 122(b) and/or gearbox 122(c) to perform the same function as integrated pump 112.

In the example described, fluid can exit from actuator network 110 and flow to selector valve 124. Based upon the configuration of selector valve 124, fluid can flow through filter 118, fuel oil cooler 116, and boost pump 108 and thereafter recirculate through fluid system 100 (i.e., through control valve 106(a) and back through actuator network 110 for additional cooling). Additionally or alternatively, fluid can flow exit from actuator network 110 and flow to selector valve 124 wherein the fluid is directed back to fluid source 102 (e.g., a fluid tank), thus replenishing fluid source 102.

In the example described, fluid system 100 provides the advantages listed above with respect to the description of FIG. 1. The additional details of fluid system 100 depicted in the schematic diagram of FIG. 2 demonstrate the minimal weight and size impact of integrated pump 112 within actuator network 110. Further, the schematic diagram of fluid system 100 depicts the manner in which multiple actuators (i.e., 110(a), 100(b), and 110(c)) receive the benefit of cooling flow via integrated pump 112.

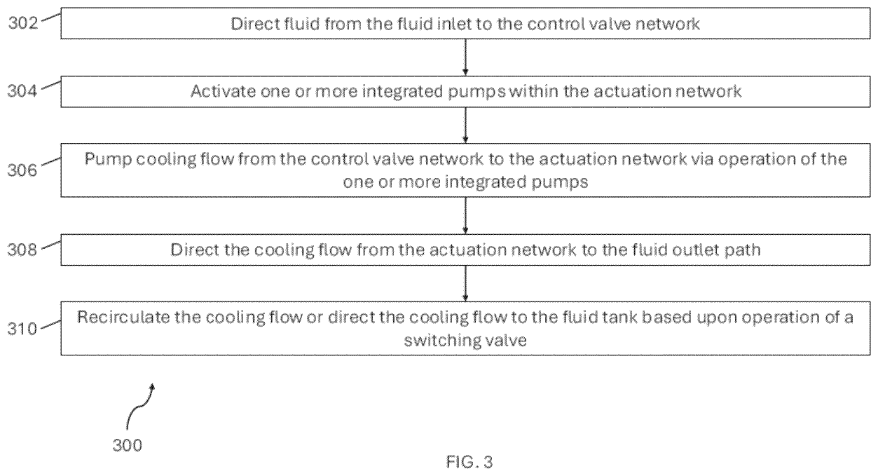

FIG. 3 is a flowchart depicting an example of method 300 for providing cooling flow to actuation network 110 via the integrated pump 112 within fuel system 100. Method 300 addresses providing cooling flow during an engine off condition to mitigate thermal soak back. In the description of method 300, reference will be made to the component numbers of FIGS. 1 and 2 for clarity.

Method 300 begins at step 302, wherein fluid is directed from fluid source 102 through fluid inlet 104 to control valve network 106. Fluid can flow through control valve network 106 based upon the operation of control valves (e.g., control valve 106(a) and control valve 106(b)) within control valve network 106.

At step 304, integrated pump(s) 112 is/are activated within actuator network 110. As depicted in FIG. 2, integrated pump(s) 112 can be one or more bi-directional pumps configured to spin the EMAs of actuator network 110 in either rotational direction. Integrated pump 112 can be a centrifugal pump integrated to the intermediate gearing of a mechanical driveline of an EMA within actuator network 110.

At step 306, integrated pump 112 pumps cooling flow from fluid inlet 104, through control valve network 106, to actuator network 110. The cooling flow can flow through downstream series connected actuators (e.g., actuator 110(a), actuator 110(b), and actuator 110(c)) to provide cooling and mitigate the effects of thermal soak back.

At step 308, the cooling flow is directed from actuation network 110 to a fluid outlet path (i.e., an exit of actuation network 110). At step 310, the cooling flow is directed to fluid source 102, or recirculated through fluid system 100 based upon operation of switching valve 124.

The techniques of this disclosure allow for an electromechanical actuation network which benefits from cooling during engine operation and during an engine off condition. During operation of the fluid system, cooling flow (e.g., cooling fuel) keeps the actuator network at an appropriate temperature for operation. Upon engine shutdown, an integrated pump housed within the actuator network provides cooling flow from the fluid source. The techniques of this disclosure thus allow EMAs to remain cool and operational upon engine shutdown.

### DISCUSSION OF POSSIBLE EMBODIMENTS

A fluid system includes a fluid inlet, a boost pump fluidically coupled to the fluid inlet, a control valve network fluidically coupled to the boost pump and to the fluid inlet, and an actuation network fluidically coupled to the check valve network. The actuation network comprises at least one actuator having an integrated pump. The fluid system further includes a fluid outlet path fluidically coupled to the actuation network.

The fluid system of the preceding paragraph can optionally include, additionally and/or alternatively, any one or more of the following features, configurations and/or additional components:

A further embodiment of the foregoing system, wherein the integrated pump is a bi-directional fluid pump configured to pump cooling fluid through the actuation network.

A further embodiment of any of the foregoing systems, wherein the control valve network comprises a first check valve and a second check valve.

A further embodiment of any of the foregoing systems, wherein the first check valve is fluidically coupled between the fluid inlet and the actuation network.

A further embodiment of any of the foregoing systems, wherein the first check valve is biased in an open position by a spring.

A further embodiment of any of the foregoing systems, wherein the first check valve is configured to be moved to a closed position in response to pressure from operation of the boost pump.

A further embodiment of any of the foregoing systems, wherein the second check valve is fluidically coupled between the boost pump and the actuation network.

A further embodiment of any of the foregoing systems, wherein the second check valve is biased in a closed position by a spring.

A further embodiment of any of the foregoing systems, wherein the second check valve is configured to be moved to an open position in response to pressure from operation of the boost pump.

A further embodiment of any of the foregoing systems, wherein the fluid outlet path is fluidically coupled to a fuel tank and wherein the fluid inlet is configured to receive fluid from the fuel tank.

A further embodiment of any of the foregoing systems, wherein the fluid outlet path is fluidically coupled to the boost pump and is thereby configured to recirculate fuel through the fluid system.

A further embodiment of any of the foregoing systems, further comprising a filter fluidically coupled to an outlet of the boost pump.

A further embodiment of any of the foregoing systems, further comprising a fuel oil cooler fluidically coupled between the filter and the boost pump.

A further embodiment of any of the foregoing systems, wherein the fluid system is housed within a gas turbine engine.

A further embodiment of any of the foregoing systems, wherein the integrated pump is configured to pump cooling flow through the actuation network while the gas turbine engine is in an off state.

A method for a fluid circuit to provide cooling to an actuation network, the fluid circuit including a fluid inlet, a boost pump fluidically coupled to the fluid inlet, a check valve network fluidically coupled to the check valve network and fluidically coupled to a main pump, and a fluid outlet path fluidically coupled to the actuation network, includes directing fluid from the fluid inlet to the control valve network. The method further includes activating one or more integrated pumps within the actuation network. The method further includes pumping cooling flow from the control valve network to the actuation network via operation of the one or more integrated pumps. The method further includes directing the cooling flow from the actuation network to the fluid outlet path.

A further embodiment of the foregoing method, wherein the fluid outlet path is fluidically coupled to a fuel tank and wherein the fuel tank supplies the fluid inlet.

A further embodiment of any of the foregoing methods, wherein the fluid outlet path is fluidically coupled to the boost pump and is thereby configured to recirculate the cooling flow through the fluid system.

A further embodiment of any of the foregoing methods, wherein the integrated pump is a bi-directional fluid pump configured to pump the cooling flow through the actuation network.

A further embodiment of any of the foregoing methods, wherein the check valve network includes a first check valve and a second check valve, and wherein the cooling flow is directed through the first valve when the boost pump is not operational.

A further embodiment of any of the foregoing methods, wherein the first check valve is fluidically coupled between the fluid inlet and the actuation network.

A further embodiment of any of the foregoing methods, wherein the second check valve is biased in a closed position via operation of a spring.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fluid system, comprising:
a fluid inlet;
a boost pump fluidically coupled to the fluid inlet;
a control valve network fluidically coupled to the boost pump and to the fluid inlet;
an actuation network fluidically coupled to the control valve network, wherein the actuation network comprises at least one actuator having an integrated pump; and
a fluid outlet path fluidically coupled to the actuation network.

2. The system of claim 1, wherein the integrated pump is a bi-directional fluid pump configured to pump cooling fluid through the actuation network.

3. The system of claim 1, wherein the control valve network comprises a first control valve and a second control valve.

4. The system of claim 3, wherein the first control valve is fluidically coupled between the fluid inlet and the actuation network.

5. The system of claim 4, wherein the first control valve is biased in an open position by a spring.

6. The system of claim 5, wherein the first control valve is configured be moved to a closed position in response to pressure from operation of the boost pump.

7. The system of claim 3, wherein the second control valve is fluidically coupled between the boost pump and the actuation network.

8. The system of claim 7, wherein the second control valve is biased in a closed position by a spring.

9. The system of claim 8, wherein the second control valve is configured to be moved to an open position in response to pressure from operation of the boost pump.

10. The system of claim 1, wherein the fluid outlet path is fluidically coupled to a fuel tank and wherein the fluid inlet is configured to receive fluid from the fuel tank.

11. The system of claim 1, wherein the fluid outlet path is fluidically coupled to the boost pump and is thereby configured to recirculate fuel through the fluid system.

12. The system of claim 1, further comprising a filter fluidically coupled to an outlet of the boost pump.

13. The system of claim 12, further comprising a fuel oil cooler fluidically coupled between the filter and the boost pump.

14. The system of claim 1, wherein the fluid system is housed within a gas turbine engine.

15. The system of claim 14, wherein the integrated pump is configured to pump cooling flow through the actuation network while the gas turbine engine is in an off state.

16. A method for a fluid circuit to provide cooling to an actuation network, the fluid circuit including a fluid inlet, a boost pump fluidically coupled to the fluid inlet, a check valve network fluidically coupled to the check valve network and fluidically coupled to a main pump, and a fluid outlet path fluidically coupled to the actuation network, the method comprising:
directing fluid from the fluid inlet to the control valve network;
activating one or more integrated pumps within the actuation network;
pumping cooling flow from the control valve network to the actuation network via operation of the one or more integrated pumps; and
directing the cooling flow from the actuation network to the fluid outlet path.

17. The method of claim 16, wherein the fluid outlet path is fluidically coupled to a fuel tank and wherein the fuel tank supplies the fluid inlet.

18. The method of claim 16, wherein the fluid outlet path is fluidically coupled to the boost pump and is thereby configured to recirculate the cooling flow through the fluid system.

19. The method of claim 16, wherein the integrated pump is a bi-directional fluid pump configured to pump the cooling flow through the actuation network.

20. The method of claim 16, wherein the control valve network includes a first control valve and a second control valve, and wherein the cooling flow is directed through the first valve when the boost pump is not operational.
